(19) United States
(12) Patent Application Publication
(10) Pub. No.: US 2001/0017622 A1
(43) Pub. Date: Aug. 30, 2001

(54) APPARATUS AND METHOD FOR GENERATING A CONFIGURABLE PROGRAM EXPLANATION USING TEMPLATES AND TRANSPARENT GRAPHICAL USER INTERFACES

(76) Inventors: SUKESH J. PATEL, SUNNYVALE, CA (US); LESTER D. NELSON, SANTA CLARA, CA (US); LIA ADAMS, PALO ALTO, CA (US)

Correspondence Address: OLIFF & BERRIDGE, P O BOX 19928, ALEXANDRIA, VA, 22320

(21) Appl. No.: 09/050,363

(22) Filed: Mar. 31, 1998

(51) Int. Cl. G09G 5/00

(52) U.S. Cl. 345/418

(57) ABSTRACT

A configurable program explanation uses templates and transparent graphical user interfaces (TGUI). A transparent image is selected by a user and generated such that the user can see through the transparent image and view an application as it was before the transparent image was applied. Once the user has selected the item to be addressed by the TGUI, various levels of the TGUI can be selected to reveal additional information about the selected item. Each level of information may contain task-appropriate or skill-level-appropriate information about the selected application. The TGUI can be edited or otherwise customized by the user to reveal information deemed appropriate or more informative to future users. Information contained in the application for which the TGUI is applied may be incorporated into the TGUI, such as formulas or row and/or column headings from a spreadsheet. Information displayed in the transparent image may be textual or graphic, and may be static or animated.

### BACKGROUND OF THE INVENTION

1. Field of Invention

This invention relates generally to an apparatus and method for providing users with explanations of a software application using a graphical user interface. More particularly, this invention relates to an apparatus and method for generating a transparent explanation image, so that a user can see through the image and view an application as it was before the image was applied. The explanation image may include newly added display information, and the information may be modified by the user.

2. Description of Related Art

Early computer systems and applications came bundled with numerous manuals explaining how the system and applications were to be used. A user of the system or application was expected to read the manuals in order to learn how to use the various aspects of the system or application. However, users were often overwhelmed by too much information, and were required to master the information to perform even simple tasks. This created a difficulty in users learning how to use the system or application. Directions in the manuals tended to walk a user through a process. In fact, many manuals contained a lengthy tutorial. Users typically wanted to get past the extremely detailed explanations and tutorials and perform their own tasks using the application or system.

In response to the many difficulties attributed to large volumes of user manuals, minimal manuals were developed. These minimal manuals were designed to allow users to immediately start on meaningful tasks and to reduce the amount of reading and other passive user activity. Furthermore, the minimal manuals also led to online help systems, where a user could access help information on an as-needed basis. For example, a HELP menu item on the application's graphical user interface permits the user to explicitly invoke the help facility. For context sensitive help, that is, help that permits a user to click the “help” button during data entry, a pop-up window may also be available. This form of help is designed to give the user information pertaining to the segment of the application currently in use.

Other available help systems include the ability to move a mouse pointer or cursor over a visible graphical user interface (GUI) element and have the system display a few words. This typically included only the name of the GUI element on a single, short, static piece of text, such as “Send Message”. The GUI element may be a push button, a pull down menu item, etc., and is an interactive object.

Some applications utilize a question and answer format, and help the user accomplish tasks by guiding the user through the application. Using this format, a user is queried in a sequential manner as the help function assists the user in performing a series of steps required to accomplish the desired work.

Many software applications also come with examples that the user can use as-is or that the user can customize to suit various needs. For example, templates may be available in word processing packages to assist a user in creating various kinds of documents, such as letterheads, resumes, memos, purchase orders, and envelopes. Other examples of templates incorporated in spreadsheets or database applications include purchase request forms, invoices, purchase orders, time cards, and sales quotes.

Transparent graphical user interfaces (TGUIs) use a lens metaphor to provide alternate meaningful views of information. A lens augments a GUI with a transparent moveable filter, providing an alternate rendering of an objects inside the boundary of the lens. These TGUIs are used primarily as a tool to explore and modify information. For example, a TGUI lens may zoom in on an image segment and provide greater detail by acting as a magnifying glass. Alternatively, the TGUI lens may modify what is viewed, such as when the lens is colored or tinted.

### SUMMARY OF THE INVENTION

This invention provides an apparatus and method for generating a configurable program explanation using templates and transparent graphical user interfaces (TGUI).

This invention further provides an apparatus and method that allows a user to incorporate text or images deemed appropriate or informative into the TGUI.

This invention further provides an apparatus and method that allows a user to elaborate and/or annotate notes attached to individual GUI elements, or a group or collection of the GUI elements, of the application user interface.

In the TGUI of this invention, a user can select an item, or a group of items, on a visual display to be addressed by a TGUI. The user can then modify the TGUI to reveal additional information about the item selected on the visual display. By incorporating appropriate or informative text or images, a user can receive help information or other text or visual information corresponding to a user selected region.

The apparatus of this invention uses a visual display having a visual display area for presenting images to a user. A user may select a first image to be displayed on the display device using a user input device. Information about the first image is retrieved from a memory by a processor. The user may alter the content of the first image using the user input device. When the user, using the input device, requests additional information about the first image, the processor accesses and retrieves from memory data providing a transparent second image. The processor receives the transparent image data, and, in response to the user request, generates a composite image of the first image and the transparent image. This new composite image is then sent from the processor for display on the visual display device.

The request for explanatory information received from the user may contain specific location information about the segment of the first image for which the explanation is desired. The processor utilizes this specific location information to retrieve specific transparent image data from memory, and incorporates information contained in the first image into the text or visual data contained in the transparent image.

Additionally, information contained in the explanatory image can be modified by a user before, during or after the composite image is displayed on the visual display device.

Furthermore, the explanatory information contained in the second image can contain multiple levels of information, and the user can access, view and modify any level. Each level can represent a different amount or type of information contained and displayed in the transparent image.

In addition, the processor can retrieve information contained in the first image, such as row and/or cell definitions for a spreadsheet, and incorporate this information into the transparent image, to supplement the explanatory information. For example, formulas and/or row and/or column headings of a first image spreadsheet can be incorporated into the textual content of the transparent image. This transfer of information can occur when the underlying structure of the application interface namely GUI element names that require explanation, is made accessible to the TGUI. This structure may be made accessible, for example, by availability of the application source code. This structure may also be made accessible through an application programmer interface (API) provided by the application that makes this structure available through a function or subroutine call.

Additionally, the information displayed using the transparent image can be text information or graphic information, and the information may be static or animated. The user can amend or annotate the information. The user can instruct the processor to retrieve information from a database and/or from the first image.

All of the help displays generate a new transparent window when the interface is a windows-based computer application. Newly opened windows according to this invention do not cover or obscure the underlying application. This is a significant advantage over conventional on-line help systems. For example, when a user wants to know the use of a GUI on a display, a help window may be opened. As discussed above, in conventional on-line help systems, the help window typically obscures the GUI item to which the query refers. This is a significant disadvantage, and is not limited to the display of a help window or template, but includes all windows.

Generally, help mechanisms often use concepts and terms developed by the person writing the software application. For example, a user may want to learn how to resume a task later. However, the help function requires a user to have knowledge that in order to resume the task later the information must first be saved to a file. An expression “saving a file” is not intuitive to a user whose only desire, and limited experience, is to resume a task later. Thus the apparatus and method of this invention allows the user to annotate the window or help function or to call up help information using language at a level that the user can understand and in terms familiar to the user.

Application programs often provide templates, which are pre-saved data in the application representing the state of the commonly performed task using that application. For example, a financial spreadsheet package may include a template for expense reporting that helps users bridge the gap between their needs and the operations they must perform in the application. In the apparatus and method of this invention, templates are enhanced to include the explanation images and content to be displayed through the TGUI, to further help the user understand the conceptual mapping between a task and how the application is used in performing such tasks.

The apparatus and method according to this invention allows editable text to be introduced within an image. Furthermore, this text can be edited or supplemented by the user. These are clear advantages over conventional TGUI systems, as the user now has textual control over the content of a help window without obscuring the underlying subject of the help text.

These and other features and advantages of this invention are described in or are apparent from the following detailed description of the preferred embodiments.

### BRIEF DESCRIPTION OF THE DRAWINGS

The preferred embodiments of this invention will be described in detail, with reference to the following figures, wherein:

FIG. 1 is a functional block diagram of a configurable display system of this invention;

FIG. 2 shows a symbolic first image displayable on a visual display device;

FIG. 3 shows a non-transparent window placed over the symbolic first image shown in FIG. 2;

FIG. 4 shows a symbolic explanation image placed over the symbolic first image;

FIG. 5 shows an explanation image according to this invention that is displayable on a visual display device;

FIG. 6 shows the explanation image placed over the symbolic first image;

FIG. 7 shows the explanation image providing a different level of explanation than the explanation image shown in FIG. 6;

FIG. 8 shows an explanation image for a pull down menu bar;

FIG. 9 is a flowchart outlining a method for generating and displaying an explanation image according to this invention;

FIG. 10 is a flowchart outlining a method for modifying the content of a transparent explanation image according to this invention; and

FIG. 11 illustrates a component architecture for the explanation image.

### DETAILED DESCRIPTION OF PREFERRED EMBODIMENTS

This invention operates in the same user interface environment and utilizes the same transparent graphical user interface apparatus and methods disclosed and claimed in U.S. Pat. No. 5,596,690, U.S. Pat. No. 5,652,851, U.S. Pat. No. 5,467,441 and U.S. Pat. No. 5,479,603, each incorporated herein by reference in its entirety.

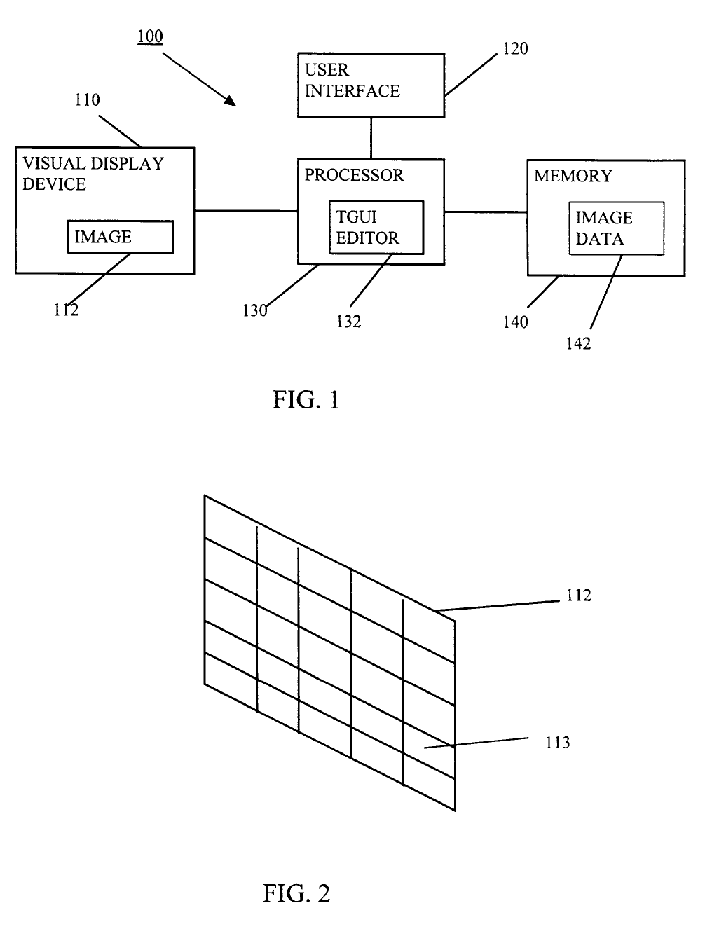

FIG. 1 is a block diagram of a system 100 for generating a configurable program explanation image, or semantic lens. The system 100 includes a visual display device 110 and a user interface 120 connected to a processor 130. The visual display device 110 may be a CRT monitor, an LCD monitor, a projector and screen, a printer, or any other device that allows a user to visually observe images.

As shown in FIG. 1, the processor 130 is preferably implemented on a programmed general purpose computer. However, the processor 130 can also be implemented on a special purpose computer, a programmed microprocessor or microcontroller and peripheral integrated circuit elements, an ASIC or other integrated circuit, a digital signal processor, a hardwired electronic or logic circuit such a discrete element circuit, a programmable logic device such as a PLD, PLA, FPGA or PAL, or the like. In general, any device, capable of implementing a finite state machine that is in turn capable of implementing the flowcharts, GUIs and apparatus shown in FIGS. 1 and 4-11, can be used to implement the processor 130.

The processor 130 is connected to a memory 140 and can retrieve and process image data 142 stored in the memory 140. The processor 130 includes a Transparent Graphical User Interface (TGUI) editor 132 which allows a user to edit an image 112 displayed on the display device 110. The image 112 may be generated from the image data 142 by the processor 130, or may be input through the user interface 120.

FIG. 2 shows the first image 112 displayed on the visual display device 110. The image 112 may take the form of any image output by an application program executing on the processor 130 and can be, for example a word processor, a spreadsheet, a database manager, a graphics generator, or any other application. The image 112 may also be a result of data input by a user, or a combination of computer generated images incorporating user input data.

The image 112 is, for example, a spreadsheet, or a visual representation of columns and rows of data. A location on the spreadsheet, which results from the intersection of a given column and a given row, is known as a cell 113. Typically, when information about a particular cell 113 in the spreadsheet is desired, the image 112 must be scrolled, or otherwise repositioned, to a different visual area of the spreadsheet corresponding to the desired information location.

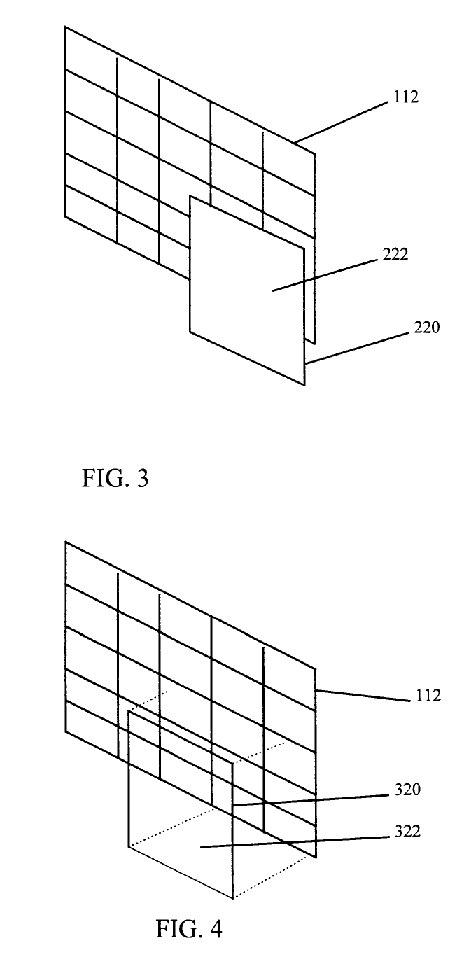

FIG. 3 illustrates a traditional help window, represented as a non-transparent window 220. As shown in FIG. 3, help text is placed on the non-transparent window 220, which has a non-transparent background 222. The non-transparent window 220 is placed on top of, or in front of, the symbolic spreadsheet image 112. This is analogous to placing the help information on a window shade, thus prohibiting a user from visually observing the object for which help or other explanatory information is desired.

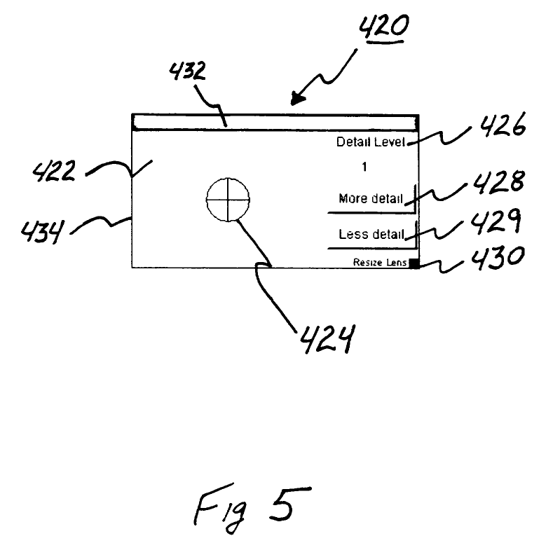

In contrast, FIG. 4 shows the symbolic spreadsheet image 112 and an explanation image 320 according to this invention. The symbolic explanation image 320 is transparent. That is, the background 322 of the symbolic explanation image 320 appears “clear and transparent,” allowing the user to view the portion of the symbolic image 112 behind the symbolic explanation image 320.

As shown in FIG. 4, the explanation image 320 is a TGUI, having various features common to computer generated windows known in the art. For example, the explanation image 320 is movable about the visual display device 110 using the same methods known in the art of moving computer generated windows.

FIG. 5 shows a first embodiment of a TGUI explanation image 420 according to this invention. Using the TGUI explanation image, or semantic lens, 420, the user can, with the aid of a pointing device, displaying a second image containing explanatory information over a first, base image. As shown in FIG. 5, the explanation image 420 includes a pointer 424. The pointer, or cross hairs 424 are used to accurately pinpoint the portion or segment of the image 112 for which an explanation is desired. The cross hairs 424 are moved about the visual display device 110 using a pointing device commonly used in computers. The pointing devices known in the art of computers include a mouse, a trackball, a touch pen, arrow keys on a keyboard, or other known ways to relocate the pointer 424 on the visual display device 110.

The level of detail control buttons 428 and 429 respectively increase and decrease the displayed level of detail. The level of detail control buttons 428 and 429 may take the form of any other control GUI, such as sliding levers, dials, thermometers, or any other representation that can be used to show and increase or decrease in detail level. A level of detail indication portion 426 indicates the level of detail of the explanation image 420. Each explanation image 420 can contain more than one level of detail. For example, the user can select a detail level containing information adapted to reveal information corresponding to user's skill levels. That is, because users have different information needs, different amounts of information can be contained in each explanation level. For example, a level directed to a novice may contain a more concise explanation than a level for a more experienced user. Similarly, the user may select the amount of text to be displayed, such as the name of a GUI element or a multi-sentence explanation of the functionality of the GUI element. Thus, the control buttons 428 and 429 allow the user to select the amount of detail displayed.

An image size control button 430 allows the user to reshape the explanation image 420. Sizing the explanation image 420 gives the user flexibility to minimize the intrusion of the explanation image 420 on the image 112. That is, the user can determine both where on the visual display device 110 the explanation image 420 is displayed, and the size and shape of the explanation image 420, to further minimize intrusion of overlapping information on top or, or in front of, the image 112. Additionally, resizing the explanation image 420 allows the user to appropriately size the window in order to display the entire content of the explanation image 420 without having to scroll or otherwise force the content to be displayed, as is known in the computer windows art. A title bar 432 identifies the name, or type, of the explanation image 420. For example, the title bar 432 indicates whether the explanation image 420 contains explanation information related to the data contained in the image 112 or help information related to how the application program (e.g. spreadsheet) has processed the data.

The background 422 is the area which displays the textual content of the explanation image 420. The background 422 of the explanation image 420 is transparent, allowing the image 112 to continue to be visible to the user on the visual display device 110. To make the explanation image 420 more visible to the user, a border, or outline 434 defines the boundaries of the background 422. Stated differently, the explanation image 420 forms a composite image with the image 112. Because the background 422 of the explanation image 420 is transparent, the content of the image 112 can be seen by the user.

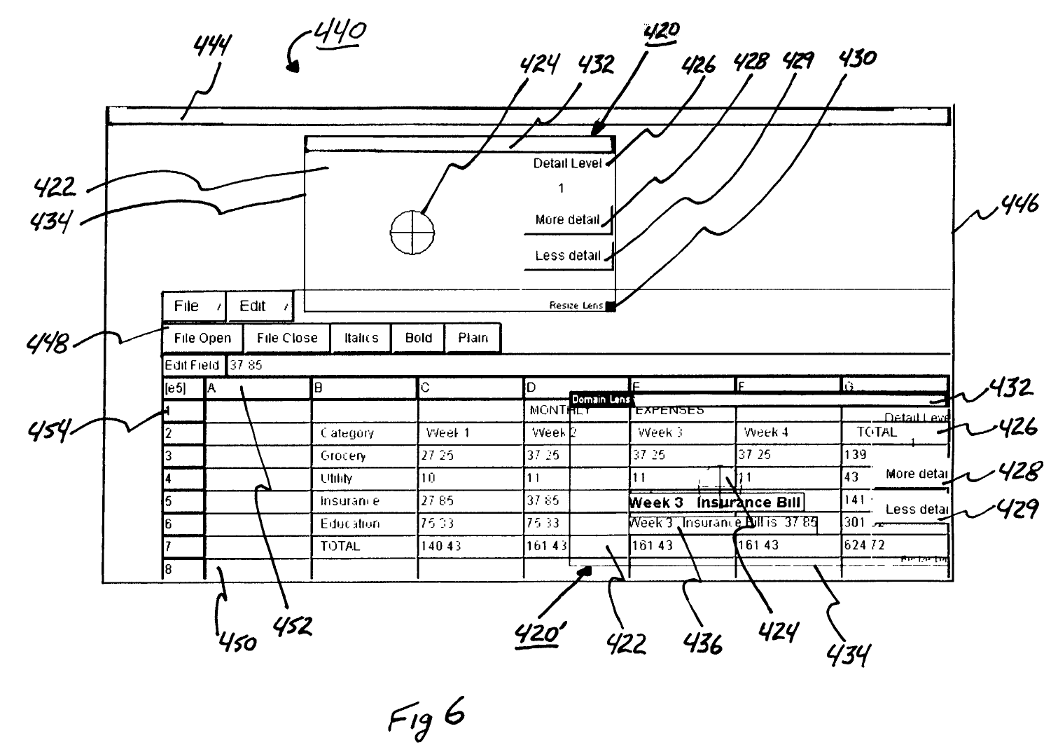

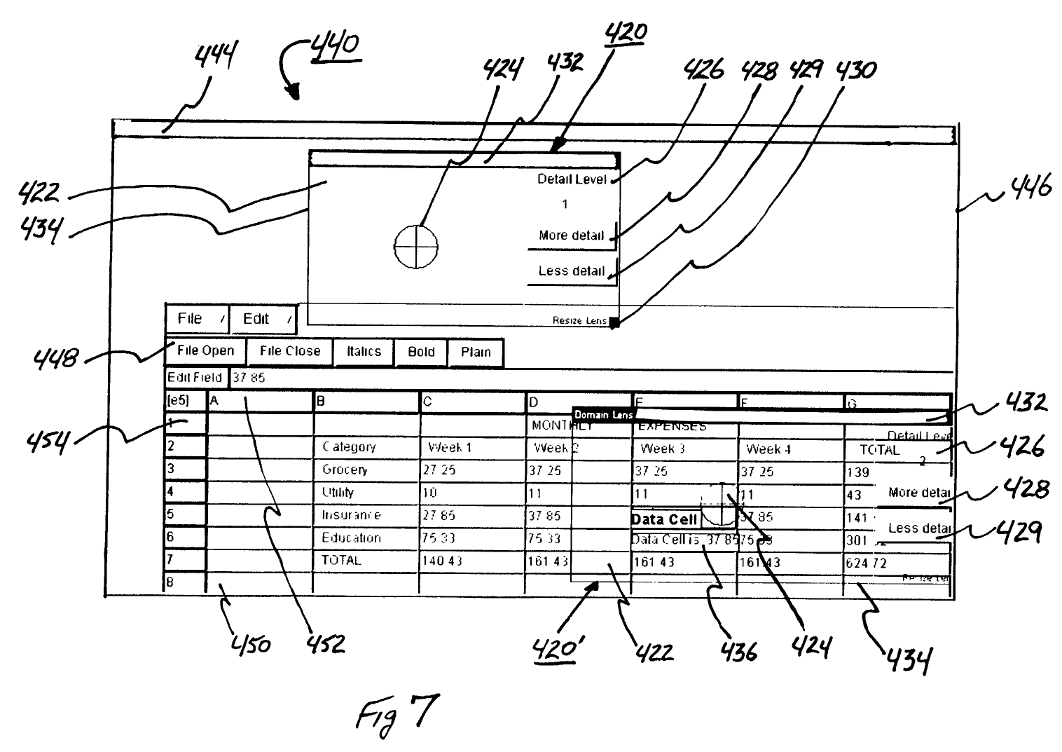

FIG. 6 shows the TGUI explanation image 420 and a second TGUI explanation image 420′ placed over a spreadsheet image 440. The spreadsheet image 440 contains similar windows features described above with respect to the explanation image 420, including a background 442, a title bar 444, a border 446, and a number of control buttons 448, 449. The title bar 444 identifies the title of the program in use, and/or other attributes of the program in use. For example, the title bar 444 can display the name of the program, the activity being performed (e.g. spreadsheet, database, letter), or any other appropriate title for the image 112 being displayed. The background 442 is the background inherent in the image 440. Additionally, the background 442 of the image 440 may be selected by the user. If the background 442 is transparent, it may be a composite of another image. To make the spreadsheet image 440 more visible to the user, a border, or outline, 446 defines the boundaries of the background 442. The control buttons 448 contain program commands which a user may activate.

The spreadsheet image 440 contains a number of cells 450 organized into a number of columns 452 and rows 454. Each cell 450 contains information unique to that particular cell, and is defined by its column and row information. For example, if the spreadsheet image 440 contains information for a household budget, each column may represent a week in a year, and each row may represent a different expense, such as, for example, groceries, utilities, and insurance. However, when spreadsheet images 440 become large, or complicated, it can become difficult to interpret the meaning of any particular cell 450.

Placing the second explanation image 420′ over a cell 450 causes an informative explanatory text 436 to be displayed in the background portion 422 of the second explanation image 420′. For example, when the cross hairs 424 are placed over, or in front of, the spreadsheet image 420 at column E, representing week 3 monthly expense, and at row 5 representing the insurance expense, the explanatory text 436 explains the expense represented by the selected cell 450. In particular, the explanatory text 436 is a first level explanatory text, as indicated by the detail level indication portion 426. That is, for week 3, the insurance bill is $37.85. In this manner, a user who is unfamiliar with the spreadsheet image 440 can place the explanation image 420 or 420′ at any location within the image 440 to discover the meaning of the information contained in the cell 450. Thus, the transparency of the TGUI explanation image 420 allows a user to see the TGUI explanation image 420 as well as the underlying spreadsheet cells of spreadsheet image 440.

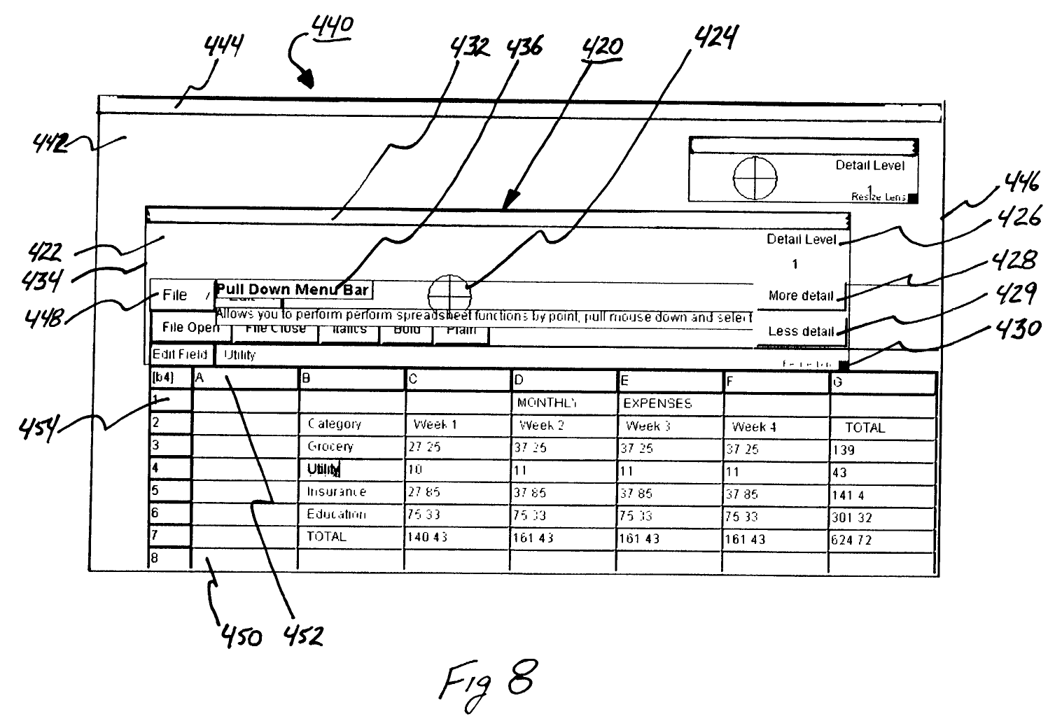

FIG. 7 shows the TGUI explanation image 420 in the same location as shown in FIG. 6. However, as shown by the detail level indication portion 426, the detail level is now set at level 2. Thus, when the second explanation window 420 is placed over cell E-5, the explanatory text 436′ is a second level explanatory text, and is different from the first level explanatory text 436 of the second explanation image 420′ shown in FIG. 4. By changing the level of detail in the explanation image 420 or 420′, the user can access differing amounts of explanatory information more suitable to the user's needs.

FIG. 8 shows the TGUI explanation image 420 placed over the spreadsheet control buttons 448. The spreadsheet control buttons 448 are typical control buttons which, when selected using a pointing device, cause some programmed event affecting the visual display of the image 420 to be performed. In FIG. 8, when the TGUI explanation image cross hairs 424 are placed in the general location of the control buttons 428, a first level text 436 is displayed. This first level text 436 explains that the control buttons 448 are located in an area of the spreadsheet image 440 known as a pull down menu bar. The first level text 436 also contains additional text about using the pull down menu bar.

If a user desires information not already contained in the TGUI explanation image 420, the user can edit or augment the information contained in the explanation image 420, so that, in the future, the user or other users will be able to benefit from the additional information. In this manner, a user can augment the information already contained in the image data 142.

Additionally, a user may want to generate a new explanatory image containing new descriptive elements, such as text or figures. A user may feel that the information already existing in the explanatory image 420 is insufficient. Thus, the user desires to annotate the explanation.

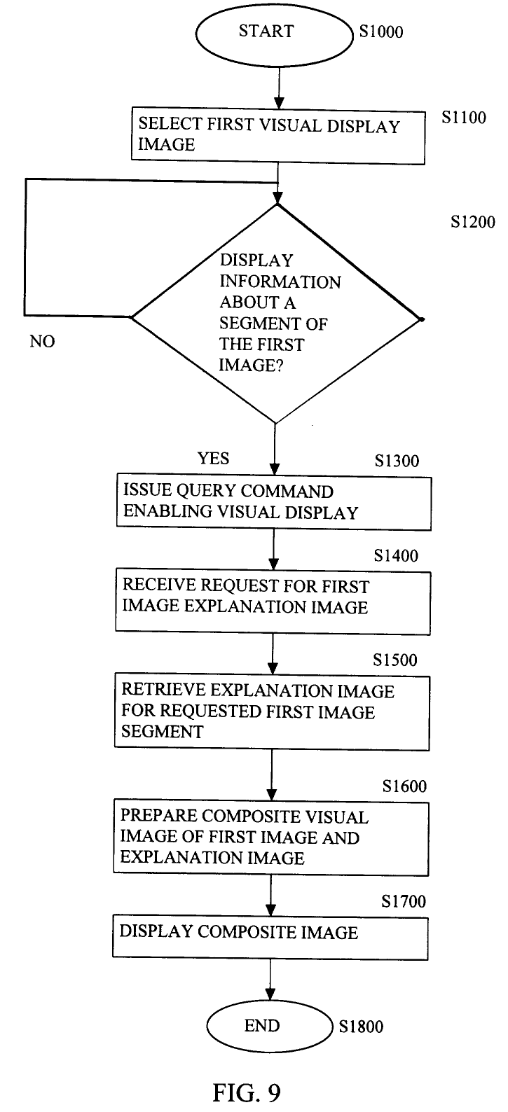

FIG. 9 outlines one preferred method for generating a composite image, such as the composite images shown in FIGS. 6-8, according to this invention. Control starts on step S1000, and continues to step S1100. In step S1100, a first visual display image is displayed. Next, in step S1200, control determines whether additional information explaining a portion of the first image is to be displayed. If not, control returns to step S1100. Otherwise, if additional information explaining a portion of the first image is desired, control continues to step S1300.

In step S1300, a query command is issued to enable an explanation image. Next, in step S1400, the request for the first explanation image is input. Then, in step S1500, explanation image data is retrieved from memory.

In step S1600, a composite visual image of the first image and the explanation image is generated using the explanation image data. Then, in step S1700, the new composite display image is displayed. Next, in step S1800, the control routine ends.

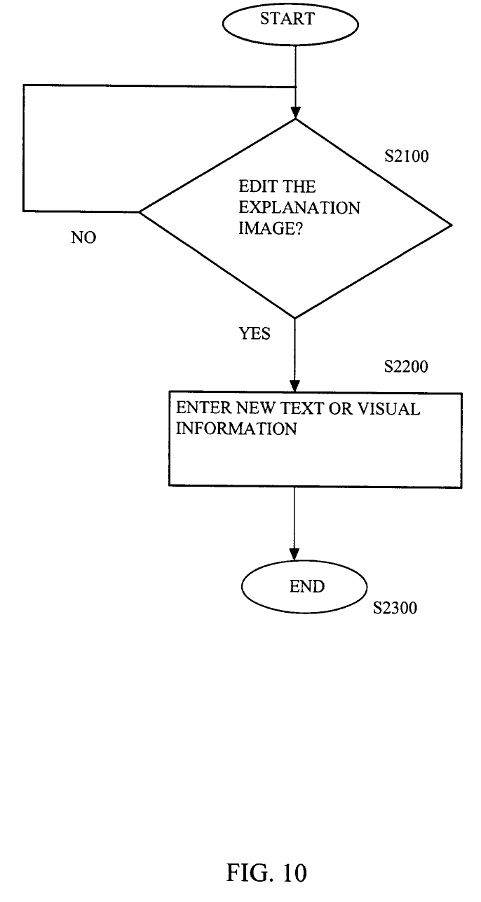

FIG. 10 outlines one preferred method for altering the information of an explanation image, such as the explanation image of FIGS. 5-8 and step S1400. Beginning in step S2000, control continues to step S2100. In step S2100, the control routine determines if there is a need to modify the explanation image. If not, control returns to step S2100. If so, control continues to step S2200. In step S2200, new text or information is entered into the explanation image. Control continues to step S2300, where the control routine ends.

It should be appreciated that the term “GUI element” includes a single GUI element or any combination or grouping of two or more GUI elements. Similarly, the term “segment” includes any portion of the underlying image, such as a single GUI element of the underlying image, or any combination, group or logical grouping of two or more segments of the underlying image. Thus, explanations may be associated with individual image segments or any combination of image segments, such as individual GUI elements or any combination of GUI elements, such as a logical grouping of the individual GUI elements.

One preferred implementation of the apparatus and method according to this invention is based on object-oriented Graphical User Interfaces (GUI) toolkits known in the art. The TGUI toolkits are designed to support the rapid construction of application GUIs with support for transparent GUIs. TGUI toolkits offer the capabilities of constraint management, flexible customization and transparent components. Constraint management allows a developer to prepare statements, or instructions, such as “place this element next to its sibling” or “let the size of this component be equal to the maximum size of its children”.

Most application GUIs need extensibility in interpreting input from the user. Flexibility in adapting the semantics of GUI elements is supported by interactive objects, called interactors, that can be refined to address the semantics of the application. In GUI systems, interactors are created as a tree of parent-child interactors such that the top-most interactor contains all other interactors. The term interactor and element may be used interchangeably.

The GUI toolkit also has the capability to construct transparent components, or see-through elements. The preferred GUI toolkit is SubArctic, developed at the Georgia Institute of Technology, incorporated herein by reference in its entirety. The apparatus and method according to this invention are not limited to this selected GUI toolkit.

Since GUIs and GUI toolkits are known in the art of graphical user interfaces, including the design and implementation of GUIs, detailed descriptions of GUI performance is omitted. In general, however, most GUIs are event driven. An event may be the click of the mouse button or the touch of the screen on a visual interface. When a GUI receives an event, the event is delivered to the relevant elements. An event handler code for the selected element is executed in response to the delivered event. The selected element passes the event to its parent if the event needs processing by the parent element. The response to an event may change the state of the selected element, its parent, its children, etc. When the element tree is changed in this manner, the GUI toolkit tracks where the modifications have occurred and which elements have had their appearances changed.

Using the GUI toolkit, a component is constructed to encapsulate the notion of the explanation image of this invention. While the following description refers to the explanation image 420 shown in FIGS. 6-8, it should be appreciated that this description is not limited to this explanation image. The explanation image 420 is implemented with a special default behavior. Whenever the explanation image 420 needs to be redrawn, or represented on the visual display device 110, the default behavior is to do a traversal. The traversal is a command sequence, from parent to child from the sub-tree rooted under the parent of the explanation image 420, discussed above. The traversal can be used to invoke specialized drawing updates under the area of the explanation image 420. Thus, a particular GUI element that is under the area of the explanation image 420 can be programmed to change its appearance.

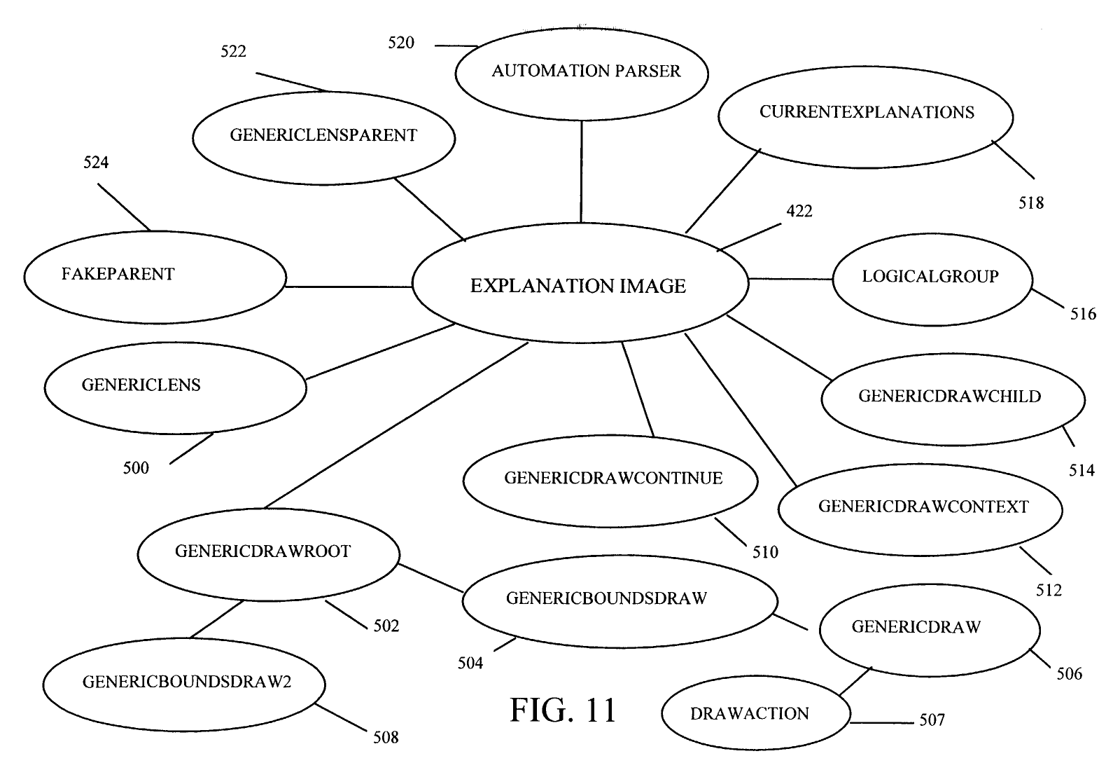

All components needed to implement the explanation image according to this embodiment are summarized in Table 1 and shown in FIG. 11. Each component is a software code comprising program instructions and data that are organized by software development techniques well-known in the art, including but not limited to, collections of subroutines, packages of related functions, and classes and objects with their related processing methods in an object-oriented programming environment.

The generic lens and the automationParser components are discussed in relation to a spreadsheet application.

In the generic lens component 500, multi-level descriptions are displayed for individual and logical groups of visible elements. For example, the user can move the explanation image 420 over a visible aspect of the displayed image 112. The explanation image 420 thus provides a two part answer, including the name of the visible aspect, such as “a row”, and a description of the visible aspect, such as “a row is a horizontal arrangement of cells”.

The automationParser component 520 is a component that enables a set of definitions to be loaded or reloaded at run time from one or more files stored in the memory 140, such that explanations can be changed at run time. For example, a novice user can be provided with a first level description that “a row is a horizontal

TABLE 1
Component Descriptions for the Explanation System.

| Component | Purpose |
|---|---|
| GenericLens | Provides a component to create an explanation |
| | image on the GUI. The image is parameterized |
| | by two components: a genericDraw component |
| | that specifies the alternate drawing behavior |
| | and a currentExplanations object that contains |
| | explanations. |
| GenericLensParent | This is a toolkit specific component that |
| | extends the redraw behavior for its children |
| | (children are instances of the explanation |
| | image or its redefinitions). Any damage, for |
| | example, leading to the possibility of a redraw, |
| | inside the area of one of its children is |
| | extended to cover the complete area of the |
| | child. |
| GenericDrawRoot | This provide a component to facilitate |
| | tree-traversal over a tree of element |
| | components. A programmer can redefine this |
| | component to provide different traversal |
| | behavior. |
| GenericBoundsDraw | This component is a specialized |
| | genericDrawRoot, making it suitable for |
| | providing multi-level explanations. |
| GenericDraw | This is a helper component for facilitating |
| | traversal over a tree of element components. |
| GenericDrawContinue | This component determines if an element |
| | tree traversal should continue to the next |
| | child element. |
| GenericDrawContext | This component Stores/Retrieves the graphics |
| | components, variables, traversal constants, |
| | and data structures that can be used by |
| | elements to draw their representation under |
| | an explanation image. |
| logicalGroup | This creates a component that can support |
| | the notion of a logical group that contains |
| | a set of elements, has a name, a description, |
| | and a single detail level. The logical group |
| | encapsulates the notion of an explanation |
| | for a structural entity. |
| currentExplanations | This create a component that can be used to |
| | store all explanations for a particular |
| | image. Each image creates an instance of this |
| | component. Various explanations can be added |
| | externally via a file or internally by the |
| | programmer. |
| automationParser | This component provides the capability that |
| | end-users can add explanations and tie them |
| | to structural entities (visible groups of |
| | elements) that can be specified in an |
| | external file and loaded/changed at run-time. |
| fakeParent | This component provides for another |
| | component that can be used to simulate a |
| | visible GUI component, and can be used |
| | to draw a perimeter around the logical |
| | group. |
| genericBoundsDraw2 | This component is a specialized |
| | genericDrawRoot, and makes it suitable for |
| | providing multi-level explanations. This |
| | component also provides support for fakeParent |
| | as a GUI component. |

collection of cells”, whereas an advanced user can be provided with a description that “a row can be treated as a cell for all practical purposes”.

The genericLens component 500 creates an image on the TGUI. The image 420 is parameterized by two components, a genericDraw component 406 and a currentExplanations component 418. The genericDraw component 406 specifies the alternate drawing behavior. The currentExplanations component 418 contains explanations for use in the explanation image 420.

Structurally, the genericLens 500 constructor accepts a drawAction component 507 and the currentExplanations component 518. The drawAction component 507 is an instance of the genericDraw component 506. The currentExplanations component 518 is a container component containing a list of logical groups. Each of the logical groups has exactly one integer that identifies the group's level. Additionally, the genericLens component 500 stores, as part of its implementation, a currentExplanations component 518, a genericDrawContext component, an image user interface that allows the user to control the detail of the explanation, and a variable to store the current logical depth at which the user wants the explanation.

Behaviorally, whenever the explanation image 420 is selected, such as when the explanation image 420 is the target of some event, such as a mouse click, the explanation image 420 determines where the event occurred and collects all of the objects whose display area includes the selected area into a “target list”. The event is then processed. If the user event, such as the clicking of the mouse, is within the cross hairs 424 of the explanation image 420, a traversal is started from the parent node using the selected element as a traversal parameter.

An alternative rendering of the area under the explanation image 420 may be called by the TGUI toolkit to change the appearance of elements under the explanation image 420. A new instance of the genericDrawContext component 512 is created, having the parameters:

(i) An integer value that defines the semantic redraw type to be of type genericDraw;

(ii) A copy of the image's graphics component, such as the drawing surface;

(iii) A currentExplanations component; and

(iv) The current logical level, such as the detail level, at which explanations should be provided.

After the drawing context has been initialized, the traversal beginning from the parent is initiated. The traversal is initiated with the key parameters:

(i) A genericDraw, or its or any redefinition of genericDraw, is input into the element as the parameter drawAction component;.

(ii) A genericDrawContinue component;

(iii) A genericDrawChild component, and

(iv) The instance of the genericDrawContext component 512 that was created.

The genericLensParent component 522 extends the redraw behavior for its children. Any damage to the image 420 that could result in the possibility of a redraw inside the area of one of its children is extended to cover the complete area of the child. This component extends the behavior for component TGUI containers, such as elements that can have children. Structurally, the genericLensParent component 522 does not declare any non-local storage.

Behaviorally, the genericLensParent component 522 defines a damage function including parameters that define the element that is damaged, that is, any change to the display data requiring a screen redraw, the coordinates for the top-left corner of the child where the damage occurred, and the size of the damaged area. This damage method first notifies its parent component, such as a toolkit specific container component, of the possibility of damage by calling the function. The damage function then iterates through all the children of the explanation image 420, to find the damaged area. On each iteration, the damage function checks to see if the area of the damage is within the area for the child. If the damage is within the child area, a damageSelf function is called. The damageSelf function notifies the drawing system that the appearance of an element may have changed and that the element should be scheduled for a redraw.

The genericDrawRoot component 502 facilitates tree-traversal over a tree of element components. This component can be redefined to provide different traversal behavior. The genericDrawRoot component 502 is a root level component that is meant to be redefined, having storage for some graphics related information and some simple default behavior. Structurally, the genericDrawRoot component 502 is defined to optionally accept Font and Color parameters.

The behavior supported by the genericDrawRoot component 502 is a boolean valued test function. The test function accepts two parameters, an interactor, and an instance or any redefinition of the genericDrawContext component 512. The interactor can be redrawn to change appearance. If the input element is an explanation image, the test function returns a false value and exits immediately. If the test determines that the element is not either fully or partially under the input graphics area, the test also returns false and exits. Otherwise, the test performs the drawing that is programmed.

The genericBoundsDraw component 504 extends the genericDrawRoot component 502, making it suitable for providing multi-level explanations. Structurally, the genericBoundsDraw component 504 extends the genericDrawRoot component 502, and includes storage to control the various drawing properties.

Behaviorally, the genericBoundsDraw component 504 re-implements the test function to return a boolean expression and accept two parameters, an input element, and a genericDrawContext component, or its redefinition. If the input element is the explanation image 420, or if the element does not fall within the area of the image, the text exits by returning a false value. After extracting the logical level, the test queries the currentExplanations component 518 for the logical group at the current detail level that contains the input element. If a logical group is found, the test draws a box or other polygon or other irregular shape around the group perimeter. The logical group 516 is then used to retrieve and display the group name and the description. This component can be easily extended to support other forms of drawing, such as scrollbars to scroll through lengthy descriptions.

The genericDraw component 506 is a helper component, which facilitates traversal over a tree of element components. The genericDraw component 506 facilitates tree traversal by implementing an interface that includes the test function, thus making sure that the input element being tested is contained in the list of targets of the genericBoundsDraw component 504. If the input element is not in the target list, the test returns a false value and exits. Otherwise, the test invokes the same test on its parent components.

The genericDrawContinue component 510 determines if the tree traversal should continue to the next child component. This component also provides a test method with two parameters, an element; and the instance of the genericDrawContext component 512. The test obtains the current physical depth and the current child number from the genericDrawContext component 512. If the current depth is greater than the maximum allowed depth defined by the genericLens component 500, the test returns a false value. If the test returns a true value, the element area intersects the graphics area of the genericDrawContext component 512. The traversal continues to the next child if the test returns a true value.

The genericDrawContext component 512 stores or retrieves graphics component, variables, traversal constants, and data structures that can be used to draw the representations of the elements under the explanation image 420. The genericDrawContext component 512 encapsulates the parameters that further define the properties of a redraw under the explanation image 420.

Structurally, the genericDrawContext component 512 is a list of elements that may need to be redrawn. The genericDrawContext component 512 also contains variables to store the current physical depth, the current child number and to hold the maximum/minimum physical depth and maximum/minimum child number. Additionally, the genericDrawContext component 512 contains variables for holding the current logical detail level of the user and the variable for holding the graphics component on which the actual redraw is to be done. Furthermore, the genericDrawContext component 512 is a currentExplanations component.

Behaviorally, the genericDrawContext component 512 has functions for setting and retrieving key variables such as the logical detail level and currentExplanations component 518.

The genericDrawChild component 514 changes drawing context properties from parent element to child element such as transforming the parent coordinates into the child's coordinate system. The current values are tested to meet the criteria before going to the child element. This component thus provides data and behavior as the TGUI element tree is traversed from the parent to the child.

Structurally, there are no genericDrawChild component scoped variables. Behaviorally, this component implements a transform function. The transform function returns a component and takes as input an instance of the genericDrawContext component 512, the element, such as the current child of the element tree, and the integer valued number for that element. The transform function checks to make sure that it received an instance of the genericDrawContext component 512 as a parameter. A test is performed to determine whether the current depth and the child numbers are within the maximum/minimum range identified in the genericDrawContext component 512. If the results are within the range, the program goes to the next child element. Before the program visits the next child, the transform method extracts the drawing surface contained in the genericDrawContext component 512 and transforms its coordinates to be in terms of the next child's coordinates.

The logicalGroup component 516 supports a logical group containing a set of elements and has a name, a description, and a single detail level. A logical group 516 encapsulates an explanation for a structural entity. This component 516 implements a meaningful definition for a logical group, and this component is designed to be used with all images. The logicalGroup component 516 enables multi-level explanations for logical groups of elements.

Structurally, variables are provided in the logicalGroup component 516 for storing and retrieving the type of group, such as vertical, horizontal and rectangular groups. Vertical groups are those groups of elements that have the same x-coordinate. Similarly, horizontal groups are those groups of elements having the same y-coordinates. Rectangular groups can have elements with different x and different y coordinates. Additionally, a constructor is provided having input parameters, including an integer logical, or detail level, a “parent” element, a name string, a description string, and an integer identifying the type of grouping, vertical, horizontal, or rectangular. The parent element may or may not be the root of the group. Furthermore, a second constructor allows a string as a parameter for the description, for example, “vertical,” “horizontal” or “rectangular.” A data structure that supports the notion of a set is also included in this component.

Behaviorally, the logicalGroup component 516 contains functions to add and delete members from the component. Functions are also provided to set and retrieve the “parent” element, as well as to set and to retrieve the logical level of the group, its name, and its description. Various helper functions are also provided, such as functions that help to compute the perimeter of the group, and functions to determine whether an element belongs to a particular group or not.

The currentExplanations component 518 can be used to store all explanations for a particular image 112. Each image 112 creates an instance of this component. Explanations can be added externally via a file 142 or internally by the programmer. An instance of this component is used for each image 112. This component holds all the logical groups for a particular explanation image 420. This component can also be used in conjunction with the automationParser component 520 to support different explanations to be loaded into the application at runtime.

Structurally, the currentExplanations component 518 has a data structure that supports the notion of a set for holding all the logical groups for an image 112. Behaviorally, the currentExplanations component 518 allows logical groups such as instances of the logicalGroup component 516 to be added as members. Additionally, methods are provided to return the logicalGroup component 516 given a logical detail level and an element as input.

The automationParser component 520 allows end-users to add explanations and tie the explanations to structural entities, i.e., visible group of elements, that can be specified in an external file and loaded and/or changed at run-time. This component implements the ability for end users to create multi-level explanations for software applications.

Structurally, the automationParser component 520 accepts three input parameters, a pointer to a file object, an instance of the currentExplanations component 518, and a symbol table containing name-value entries. Names corresponding to visible GUI elements such as “fileOpen,” which refers to the fileOpen button on the application GUI, may be used. Storage is also provided to hold a parse tree.

Behaviorally, the automationParser component 520 first opens the file and checks to verify that the file can be read. A file that can be read is parsed. As part of parsing the files, the automationParser component 520 performs actions that update the currentExplanations input component 518. When a new group definition is encountered in the file, the automationParser component 520 uses the definition of the logical group to create a new instance of the logicalGroup component 516. This group is then added to the currentExplanations component 518 for the image. The automation parser component 520 uses a symbol table populated with the names-component pairs for all visible GUI elements to retrieve the actual GUI component. Thus, the automationParser component 520 adds groups to the currentExplanations component 518 without retrieving the groups. This also allows for delivering the application with pre-defined explanations.

The fakeParent component 524 is a component that can be used to simulate a visible GUI element, and can be used to draw a perimeter around a logical group. This component therefore, facilitates the development of logical groups.

Structurally, the constructor of the fakeParent component 524 accepts two elements as input, the upper left corner element of the group, and the lower right corner of the group. It should be appreciated that, by increasing the number of elements and a type identifier, arbitrarily shaped logical groups may be supported. The type identifier may be, for example, a circle.

Behaviorally, the fakeParent component 524 uses constraint management techniques to specify the visual properties of the logical group when it is drawn. When an instance of the fakeParent component 524 is created to represent a logical group, the implementation defines a series of constraints. The first constraint occurs when the origin of the fakeParent component 524 is defined to be the x-coordinate and the y-coordinate of the input upper left corner element. A second constraint occurs when the width of the fakeParent component 524 is defined to be the right edge of the lower right input element minus the x-coordinate of the input upper left element. A third constraint occurs when the height of the fakeParent component 524 is defined to be the bottom of the input lower right element minus the y-coordinate of the input upper left element. Once the constraints are defined in this manner, routines can be provided yielding explanations that begin within the perimeter of the logical group.

The genericBoundsDraw2 component 508 is a specialized version of genericDrawRoot component 502, and is suitable for providing the multi-level explanations and for providing support for the fakeParent component 524 as a GUI element.

Structurally, the genericBoundsDraw2 component 508 contains local variables for controlling various display properties such as the pen color, the display font, and whether or not to draw a perimeter around the group, etc.

Behaviorally, the genericBoundsDraw2 component 508 contains test functions which are provided to retrieve and change the display properties. Additionally, the test functions accept two parameters, an element, and an instance of the genericDrawContext component 512. The input element and the current logical level are used to retrieve a logical group from the currentExplanations component 518. If no group is found, no alternate drawing is performed and the test returns. The test first checks to make sure that the parent of the logical group is not the same as the input element, and if the two are the same, no adjustments need to be made to the origin. If the parents of the logical group and the input element are different, the functions “getXFactor” and “getYfactor” of the logicalGroup component 516 are used to adjust the graphic's origin. A perimeter around the group/widget can then be drawn. Then, the name and the description is drawn with respect to the selected input element to make it immediately visible. By moving or enlarging the image, the whole perimeter of the logical group can be made visible.

The Automation Parser component 520 allows the user to specify the explanations in a file. The explanation parser reads a file that contains the explanations and populates an instance of a currentExplanations component 518 for a particular explanation image 420. Thus, when an alternate redraw is performed for elements under an explanation image 420, the change in the currentExplanations component 518 enables new descriptions to be delivered to the user.

The automation parser component 520 is implemented with the help of the following components and is based on known concepts of programming languages and compiler technology:

1. autoToken: a component that encapsulates the type and the value of a lexical token;

2. automationNode: a component that encapsulates the notion of a node in a parse tree;

3. symbolTable: a component the associates name value pairs for identifiers;

4. automationParser: a component that parses a file for an image;

5. fakeParent: a component that supports the notion of a logical group that does not have an element tree rooted at a common parent element; and

6. genericDrawBounds: the drawing display component that improves upon currentExplanationsDraw.

Tokens, parse trees, nodes and symbol tables are well known to software practitioners and will not be discussed in further detail.

An automation grammar is used to define multi-level explanations that can be produced by users in a convenient, easy-to-use manner after the release of a product, such as a software application. The automation grammar can also be used by vendors to ship the software application with built-in explanations. For example, a user/vendor can create one file for each type of image in the application. The user is provided with a list of valid component, or element, identifiers. This list is provided by the vendor of the application as part of the documentation. The user then creates multi-level explanations for any template (i.e., the image created with the software application). These files are then loaded with the template and thereafter provide the user/customer with multi-level explanations, with support for showing structural relationships of the GUI elements.

An example of the grammar for the image automation is given in Table 2.

An application developer may create an explanation image 420 by first creating a symbol table of name-value pairs for visible GUI elements. For example, if the GUI element is a button, such as, for example a FILE button, and it is available to open a file in the application, then the tuple <“fileOpen”, fileButton> is added to the symbol table, where “fileOpen” is the handle or name of the actual GUI element. Next, the developer creates an instance of the currentExplanations component 518 for the explanation image 420.

TABLE 2
Image Automation Grammar.

| | |
|---|---|
| lensFile | → lens lensIdentifier‘{‘logicalUnitList‘}’ |
| logicalUnitList | → logicalDescription logicalUnitList \| ε |
| logicalDescription | → logical identifier‘{‘descriptionUnit‘}’ |
| descriptionUnit | → level integer‘;’type typeIdentifiers‘;’ |
| | name string’;’description descriptionString’;’ |
| | upperLeftCorner componentIdentifier’;’ |
| | lowerRightCorner componentIdentifier‘;’ |
| | components componentList |
| descriptionString | → string \| reference string |
| componentList | → component‘;’componentList \| ε |
| component | → componentIdentifier |
| identifier | → {alpha+(digit \| alpha)*}- |
| | {{componentIdentifier}+ |
| | {lensIdentifier}} |
| string | → ‘’”(alpha \| digit \| punctuation)*‘’” |
| alpha | → [a-zA-Z] |
| digit | → [0-9\| |
| punctuation | → !\|@\|#\|$\|%\| . . . // any printable ascii character but |
| | not a digit // or an alpha character |
| componentIdentifier | → . . . // any valid visible widget that can be named |
| lensIdentifier | = {‘jargonLens’, ‘domainLens’, ‘HowDoILens’} |
| typeIdentifiers | = {‘horizontal’, ‘vertical’, ‘rectangular’} |

An instance of the genericLens component 500, or some redefinition of genericLens component 500, if specialized code is needed, is then created with key parameters including, the coordinates where the image should be displayed on the screen, the size of the image, the genericBoundsDraw component 504, a unique integer value that is different for each image, a pointer to the currentExplanations component 518 that was previously created, and a name for the image.

The implementation provides a GUI element that is an instance of the genericLensParent component 522. The genericLensParent component 522 is an element that is contained in the application GUI window. The instance of genericLens component 500 that was created above is added as a child of the genericLensParent element.

The developer then populates the instance of the currentExplanations component 518. In this manner, the developer declares instances of the logicalGroups component 516 and adds these groups to the currentExplanations component 518. If the explanations need to be populated by an external file, an instance of the automationParser component 520 is created, including a pointer to a file that contains the explanations as per the explanation grammar syntax, a symbol table, and a pointer to the currentExplanations component 518.

While this invention has been described in conjunction with the specific embodiments outlined above, it is evident that many alternatives, modifications and variations will be apparent to those skilled in the art. Accordingly, the preferred embodiments of the invention as set forth above are intended to be illustrative, not limiting. Various changes may be made without departing from the sprit and scope of the invention as defined in the following claims.

What is claimed is:

1. A display device comprising:
a display that displays images, and having a display area;
an input device that receives signals;
a memory that stores data, the stored data including a first image and second image data;
a processor connected to the memory, the display and the input device, the processor receiving data from the input device, accessing data stored in the memory, and providing at least the first image data to the display;
wherein:
the processor, in response to data received from the input device, generates a second image from the second image data and displays the second image coextensively and at substantially the same time as the first image, the first and second image forming a composite image, and
the second image contains information related to a segment of the first image.

2. The display device of claim 1, wherein the second image information is alterable.

3. The display device of claim 1, wherein the second image information is help information.

4. The display device of claim 1, wherein the second image comprises a foreground and a background.

5. The display device of claim 4, wherein the foreground of the second image contains information about the first image.

6. The display device of claim 4, wherein the background of the second image is transparent.

7. The display device of claim 4, wherein the foreground contains editable textual information.

8. The display device of claim 1, wherein the second image data contains a plurality of selectable information levels.

9. The display device of claim 8, wherein each of the plurality of levels is editable by the user.

10. The display device of claim 1, wherein the second image is relocatable in the display area without affecting the underlying first image.

11. The display device of claim 1, wherein the segment is one of a portion of the first image, a graphical user interface element of the first image and a combination of at least two graphical user interface elements of the first image.

12. A method for visually displaying images, comprising:
displaying a first image;
receiving a request for a second image containing information about a segment of the first image;
retrieving a second image from a database;
generating a third image based on the first image and the second image;
displaying the third image.

13. The method of claim 12, wherein the second image is a transparent image.

14. The method of claim 12, wherein the third image is a composite image of the first image and the second image.

15. The method of claim 12, wherein the information contained in the second image is editable.

16. The method of claim 12, wherein the second image has a plurality of levels.

17. The method of claim 16, wherein each of the plurality of levels displays retrieved information about the first image.

18. The method of claim 16, further comprising selecting one of the plurality of levels of the second image, wherein each of the plurality of levels contains different amounts of information corresponding to a selected segment of the first image.

19. The method of claim 12, further comprising:
selecting a level of information about the segment of the first image;
retrieving the selected level of information from the database;
regenerating the third image incorporating the selected level of information; and
displaying the regenerated third image.

20. The method of claim 19, further comprising:
receiving a request to alter the information about the segment of the first image;
altering the information;
regenerating the third image incorporating the altered information; and
displaying the regenerated third image.

21. The method of claim 20, further comprising saving the altered information to the database.

22. The method of claim 20, wherein the altered information is help information.

23. The method of claim 12, wherein the segment is one of a portion of the first image, a graphical user interface element of the first image and a combination of at least two graphical user interface elements of the first image.

24. A graphical user interface, comprising:
a first display portion that displays a first image, and
a second display portion that displays a second image, the second display portion comprising:
a segment selector that selects a segment of the first image, and
a information display section that displays information associated with the selected segment, the information display section having a transparent background.

25. The graphical user interface of claim 24, wherein the information associated with the selected segment is editable.

26. The graphical user interface of claim 24, wherein the second display portion further comprises:
a level indicator section that indicates a level of detail of the information displayed in the information display section;
a first level selecton button that increases a level of detail of the information displayed in the information display section about the selected segment; and
a second level selecton button that decreases the level of detail of the information displayed in the information display section about the selected segment;

27. The graphical user interface of claim 24, wherein the selected segment is one of a portion of the first image, a graphical user interface element of the first image and a combination of at least two graphical user interface elements of the first image.
